(19) United States
(12) Patent Application Publication
(10) Pub. No.: US 2009/0053630 A1
(43) Pub. Date: Feb. 26, 2009

(54) METHOD OF PREPARING TONER AND TONER PREPARED USING THE METHOD

(75) Inventors: Jun-young LEE, Yongsan-gu (KR); Kyung-yol Yon, Seongnam-si (KR); Min-young Cheong, Seoul (KR); Yo-da Shin, Metropolitan-city (KR); Tae-hoe Koo, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/051,171

(22) Filed: Mar. 19, 2008

(30) Foreign Application Priority Data
Aug. 24, 2007 (KR) 2007-85570

(51) Int. Cl. G03G 13/14; G03G 15/00; G03G 9/087

(52) U.S. Cl. 430/48; 430/137.11; 430/109.3; 399/159

(57) ABSTRACT

A method of preparing toner, the method including: preparing latex particles for a core which contain wax by polymerizing a toner composition comprising at least one polymerizable monomer and a macromonomer having a hydrophilic group, a hydrophobic group, and at least one reactive functional group; mixing the latex particles for a core with a self-dispersable pigment dispersion and adding an inorganic salt thereto to prepare a primarily agglomerated toner; and coating latex particles for a shell layer on the primarily agglomerated toner. In addition, a toner prepared using the preparation method, a method of forming image using the toner, and an image forming apparatus using the toner. Accordingly, pigments can be uniformly dispersed even without using an emulsifying agent and a dispersant, and thus images that are uniformly transferred can be obtained, and toner with long-term storage and excellent durability can be prepared.

### CROSS-REFERENCE TO RELATED APPLICATIONS

This application claims the benefit of Korean Patent Application No. 10-2007-0085570, filed on Aug. 24, 2007, in the Korean Intellectual Property Office, the disclosure of which is incorporated herein in its entirety by reference.

### BACKGROUND OF THE INVENTION

1. Field of the Invention

The present general inventive concept relates to a method of preparing toner and toner prepared using the method, and more particularly, to a method of preparing toner without using an emulsifying agent and a dispersant, toner prepared using the method, a method of forming images using the toner, and an image forming apparatus employing the toner.

2. Description of the Related Art

In an electrophotographic process or electrostatic recording process, developers used to form an electrostatic image or an electrostatic latent image can be classified into: two-component developers formed of toner and carrier particles; and one-component developers which are formed of toner only and do not include carrier particles. One-component developers can be further classified into magnetic one-component developers and nonmagnetic one-component developers. Fluidizing agents such as colloidal silica are often independently added to the nonmagnetic one-component developers to increase the fluidity of toner. Typically, coloring particles obtained by dispersing a coloring agent such as carbon black or other additives in a binder resin are used in toner.

In an image forming device such as an electrophotographic device or an electrostatic recording device, an image is formed by exposing an image on a uniformly charged photoreceptor to form an electrostatic latent image; attaching toner to the electrostatic latent image to form a toner image; transferring the toner image onto a transfer member such as transfer paper or the like; and then fixing the toner image on the transfer member by any of a variety of methods, including heating, pressurizing, solvent steaming, and the like. In most fixing processes, the transfer member with the toner image passes through fixing rollers and pressing rollers, and by heating and pressing, the toner image is fused to the transfer member.

Images formed by an image forming apparatus such as an electrophotocopier should satisfy requirements of high precision and accuracy. Conventionally, toner used in an image forming apparatus is usually obtained using pulverization. In pulverization, coloring particles having a large range of size distribution are formed. Hence, to obtain satisfactory developing properties, there is a need to sort the coloring particles obtained through pulverization according to size in order to reduce the particle size distribution. However, it is difficult to precisely control the particle size and the particle size distribution using a conventional mixing/pulverizing process in the preparation of toner suitable for an electrophotographic process or an electrostatic recording process. Also, when a fine-particle toner is prepared, the toner preparation yield is reduced by the sorting process. In addition, there are limits in changing/adjusting a toner design for obtaining desirable charging and fixing properties. Accordingly, polymerized toner, the particle size of which is easy to control and which do not need to undergo a complex manufacturing process such as sorting, or the like have been highlighted recently.

When toner is prepared through polymerization, polymerized toner having a desired particle size and particle size distribution can be obtained without pulverizing or sorting.

In the polymerization method, toner is generally prepared by mixing a polymerizable monomer, a pigment dispersion, an emulsifying agent, a dispersant, and a latex to form a core; agglomerating the core particles; forming a shell layer using an emulsifying agent, a dispersant, and a latex; and encapsulating the toner particles.

Herein, since pigments have a hydrophilic property and a lipophilic property, the pigments are not mixed with water. Thus, to water disperse the pigment, water dispersion is performed in a high speed mixer using a pigment dispersant. The pigment dispersed using the dispersant is agglomerated with a core latex in an agglomeration process, and coated with a shell to form toner particles. The toner particles are prepared in water base, and the dispersant contained in a pigment dispersion exists in two operations of toner agglomeration and melting. That is, in the toner agglomeration and melting operations, the dispersant exists inside the toner by being mixed with the latex together with the pigment, and exists outside the toner as a residue dispersant remaining in the water base and a dispersant attached to a surface of the toner. The pigment dispersant contained in the toner has a hydrophilic property, and thus it negatively affects toner characteristics as impurities. In particular, the pigment dispersant migrates to the surface of the toner in high temperature and high humidity conditions, and thus it affects the percentage of moisture content of the toner. As a result, the dispersant negatively affects the charge and storage properties of the toner. Due to this, images have reduced quality, and the toner becomes unstable. Therefore, to minimize the amount of the dispersant which acts as impurities having such bad impacts, the dispersant is conventionally removed by washing in subsequent processes of preparing the toner. Herein, to remove the dispersant and the emulsifying agent, which are attached to the surface of the toner, several repeated washings and a large amount of washing water are required. Therefore, this increases the manufacturing costs and wastewater.

In addition, with respect to the toner structure, when the pigment is dispersed using a conventional dispersant, pigment particles can not be completely dispersed, and thus the pigment particles are agglomerated with each other. Accordingly, it is difficult to control the optical density of printed images.

### SUMMARY OF THE INVENTION

The present general inventive concept provides a method of preparing toner in which pigments are not agglomerated with each other even without using a dispersant and an emulsifying agent and are uniformly dispersed inside the toner.

Additional aspects and utilities of the present general inventive concept will be set forth in part in the description which follows and, in part, will be obvious from the description, or may be learned by practice of the general inventive concept.

The present general inventive concept also provides toner having uniform optical density and excellent image quality.

The present general inventive concept also provides a method of forming images having uniform optical density and excellent quality.

The present general inventive concept also provides an image forming apparatus which forms images with uniform optical density and excellent quality.

The forgoing and/or other aspects and utilities of the present general inventive concept are achieved by providing a method of preparing toner, comprising: preparing latex particles for a core which contain wax by polymerizing a toner composition comprising at least one polymerizable monomer and a macromonomer having a hydrophilic group, a hydrophobic group, and at least one reactive functional group; mixing the latex particles for a core with a self-dispersable pigment dispersion and adding an inorganic salt thereto to prepare a primarily agglomerated toner; and coating latex particles for a shell layer on the primarily agglomerated toner.

According to another aspect of the present general inventive concept, there is provided a toner prepared by a method comprising: preparing latex particles for a core which contain wax by polymerizing a toner composition including at least one polymerizable monomer and a macromonomer having a hydrophilic group, a hydrophobic group, and at least one reactive functional group; mixing the latex particles for a core with a self-dispersable pigment dispersion and adding an inorganic salt thereto to prepare a primarily agglomerated toner; and coating latex particles for a shell layer on the primarily agglomerated toner.

The forgoing and/or other aspects and utilities of the present general inventive concept are also achieved by providing a method of forming an image, the method comprising attaching a toner to a surface of a photoreceptor on which an electrostatic latent image is formed to form a visualized image and transferring the visualized image to a transfer medium, wherein the toner is prepared using a method comprising: preparing latex particles for a core which contain wax by polymerizing a toner composition including at least one polymerizable monomer and a macromonomer having a hydrophilic group, a hydrophobic group, and at least one reactive functional group; mixing the latex particles for a core with a self-dispersable pigment dispersion and adding an inorganic salt thereto to prepare a primarily agglomerated toner; and coating latex particles for a shell layer on the primarily agglomerated toner.

The forgoing and/or other aspects and utilities of the present general inventive concept are achieved by providing an image forming apparatus comprising: an organic photoreceptor; a unit for charging a surface of the organic photoreceptor; an image forming unit that forms an electrostatic latent image on a surface of the organic photoreceptor; a unit for receiving toner; a toner image developing unit that develops the electrostatic latent image on the surface of the organic photoreceptor by supplying the toner; and a toner transferring unit that transfers the toner image to a transfer medium from the surface of the organic photoreceptor, wherein the toner is prepared using a method comprising: preparing latex particles for a core which contain wax by polymerizing a toner composition including at least one polymerizable monomer and a macromonomer having a hydrophilic group, a hydrophobic group, and at least one reactive functional group; mixing the latex particles for a core with a self-dispersable pigment dispersion and adding an inorganic salt thereto to prepare a primarily agglomerated toner; and coating latex particles for a shell layer on the primarily agglomerated toner.

According to the present general inventive concept, pigments are uniformly dispersed even without using an emulsifying agent and a dispersant, and thus less change in charging characteristics according to environmental changes is obtained, and images that are uniformly transferred can be obtained. In addition, the toner has a less change in the percentage of moisture content even under high temperature and high humidity conditions, thereby having improved long-term storage properties, and a reduction in toner fluidity due to high percentage of moisture content is prevented so that durability of the toner is improved. Furthermore, the amount of used washing water is reduced and manufacturing processes are simplified, and thus producing costs can be reduced. In particular, by using a self-dispersable pigment, various problems caused by excessively using an emulsifying agent and a dispersant can be solved.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a view illustrating a process of water-dispersing a pigment using a conventional dispersant;

FIG. 2 is a view illustrating a process of self water-dispersing a pigment that is surface-treated with a sulfonic acid group or a carboxyl group;

FIG. 3 is a view explaining a method of preparing toner according to an embodiment of the present general inventive concept;

FIG. 4 is a view of an image forming apparatus according to an embodiment of the present general inventive concept, which uses toner prepared using the method according to the embodiment of FIG. 3; and

FIGS. 5A and 5B are scanning electron microscopy (SEM) images of toner prepared using a preparation method of toner according to an embodiment of the present general inventive concept, at ×10,000 magnification and ×2,000 magnification, respectively.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

An embodiment of the present general inventive concept provides a method of preparing toner, the method including: preparing latex particles for a core which contain wax by polymerizing a toner composition including at least one polymerizable monomer and a macromonomer having a hydrophilic group, a hydrophobic group, and at least one reactive functional group; mixing the latex particles for a core with a self-dispersable pigment dispersion and adding an inorganic salt thereto to prepare a primarily agglomerated toner; and coating latex particles for a shell layer on the primarily agglomerated toner.

The preparing of the latex particles for a core which contain wax includes dissolving a toner composition which includes at least one polymerizable monomer and a macromonomer having a hydrophilic group, a hydrophobic group, and at least one reactive functional group together with wax and polymerizing the resultant to prepare polymer latex core particles; and adding a monomer to the polymer latex core particles to form a shell layer, thereby forming a latex core-shell structure. The prepared latex containing wax is agglomerated with a pigment dispersion to prepare a toner core.

A molecular weight, glass transition temperature (T_{g}), and rheological properties of the toner core prepared according to the method described above may be controlled to be fixed at a low fixing temperature.

The rheological properties are determined by complex modulus, i.e., storage modulus (G′) and loss modulus (G′) determined by dynamic tests, and controlled by complex viscosity. In addition, the relaxation modulus of elasticity and relaxation time can be measured. Such stress-relaxation behavior is affected by molecular weight and structure of the toner binder resin, and the amount of wax contained in the toner. When the complex viscosity is too low (1.0×10² Pas or less), offset or peeling failure may occur in a fusing device. On the other hand, when the complex viscosity is too high (1.0×10⁴ Pas or more), adhesion may not be sufficient when the toner is fixed on paper and glossiness is degraded, and thus the toner may not be efficiently applied to paper.

In addition, when the molecular weight (M_{w}) of the binder resin is controlled to be less than 30,000, T_{g} is controlled to be about 50° C., and the rheological properties are decreased, the fusing ratio can be increased, but problems such as offset may occur. To overcome such problems, a method of cross-linking resins has been used by controlling reactivity of the macromonomer participating in the polymerization. However, problems such as decrease in durability have not been completely overcome. Accordingly, in the present general inventive concept, toner is encapsulated by forming a shell layer to improve durability and to solve storage problems during shipping and handling.

Since the macromonomer used as a comonomer during the polymerization of the latex according to the present general inventive concept maintains stability of the latex in an aqueous solution, a surfactant does not need to be used in the preparation and agglomeration of polymer latex particles.

That is, at least one operation of the preparing of the latex particles for a core, the preparing of the primarily agglomerated toner and the coating of the latex particles for a shell layer on the primarily agglomerated toner may be carried out in the absence of a surfactant.

The macromonomer used herein is an amphiphilic material which has a hydrophilic group and a hydrophobic group in a polymer or oligomer form having at least one reactive functional group at its end.

The hydrophilic group of the macromonomer, which is chemically combined on the surface of toner particles, improves long term stability of the toner particles by steric stabilization, and the size of latex particles can be adjusted according to the amount or molecular weight of the added macromonomer. The hydrophobic group of the macromonomer, which is on the surface of the toner particles, can facilitate emulsion polymerization reaction. The macromonomer may form a copolymer with the polymerizable monomer included in the toner composition by grafting, branching, cross-linking, or the like.

A weight average molecular weight of the macromonomer may be in the range of 100 to 100,000, and preferably 1,000 to 10,000. When the weight average molecular weight of the macromonomer is less than 100, physical properties of the toner are not improved or the toner cannot efficiently function as a stabilizer. On the other hand, when the weight average molecular weight of the macromonomer is greater than 100,000, the reaction conversion rate may be lowered.

The macromonomer may be a material selected from the group consisting of polyethylene glycol (PEG)-methacrylate, polyethylene glycol (PEG)-ethyl ether methacrylate, polyethylene glycol (PEG)-dimethacrylate, polyethylene glycol (PEG)-modified urethane, polyethylene glycol (PEG)-modified polyester, polyacrylamide (PAM), polyethylene glycol (PEG)-hydroxyethyl methacrylate, hexafunctional polyester acrylate, dendritic polyester acrylate, carboxy polyester acrylate, fatty acid modified epoxy acrylate, and polyester methacrylate, but is not limited thereto.

The macromonomer can function not only as a comonomer, but also as a stabilizer. Initial reaction of radicals and monomers creates oligomer radicals and shows an in-situ stabilization effect. An initiator dissolved by heat creates radicals and reacts with a monomer in an aqueous solution to form an oligomer radical, and the hydrophobicity of the solution increases. Such hydrophobicity of oligomer radicals facilitates diffusion into micelle and facilitates reaction with polymerizable monomers, and together with this, a copolymerization reaction with macromonomers can be processed.

Due to the hydrophilicity of the macromonomer, copolymerization can easily occur in the vicinity of the surface of the toner particles. The hydrophilic portions of the macromonomer located on the surface of the toner particles increase stability of the toner particles by steric stabilization, and the size of the toner particles can be adjusted according to the amount or molecular weight of the macromonomer. Also, functional groups reacting on the surface of the toner particles can improve the frictional electrical properties of the toner.

The polymerizable monomer may be selected from a vinyl monomer, a polar monomer having a carboxyl group, a monomer having an unsaturated ester group, and a monomer having a fatty acid group.

The polymerizable monomer may be at least one monomer selected from the group consisting of styrene-based monomers such as styrene, vinyl toluene, and α-methyl styrene; acrylic acid or methacrylic acid; derivatives of (metha)acrylates such as methyl acrylate, ethyl acrylate, propyl acrylate, butyl acrylate, 2-ethylhexyl acrylate, dimethylamino ethyl acrylate, methyl methacrylate, ethyl methacrylate, propyl methacrylate, butyl methacrylate, 2-ethylhexyl methacrylate, dimethylaminoethyl methacrylate, acrylonitrile, methacrylonitrile, acrylamide, and metacryl amide; ethylenically unsaturated monoolefins such as ethylene, propylene, and butylenes; halogenized vinyls such as vinyl chloride, vinylidene chloride, and vinyl fluoride; vinyl esters such as vinyl acetate, and vinyl propionate; vinyl ethers such as vinyl methyl ether, and vinyl ethyl ether; vinyl ketones such as vinyl methyl ketone, and methyl isoprophenyl ketone; and nitrogen-containing vinyl compounds such as 2-vinylpyridine, 4-vinylpyridine, and N-vinyl pyrrolidone, but is not limited thereto.

The toner composition used herein may include approximately 0.1 to 10 parts by weight, preferably 2 to 6 parts by weight, and more preferably 2 to 4 parts by weight, of macromonomer based on 100 parts by weight of polymerizable monomer.

When the amount of the macromonomer is less than 0.1 parts by weight based on 100 parts by weight of polymerizable monomer, dispersion stability of the toner particles are reduced, and toner yield may be decreased. On the other hand, when the amount of the macromonomer is greater than 10 parts by weight based on 100 parts by weight of polymerizable monomer, physical properties of the toner may be deteriorated.

The latex particles for a shell layer may be prepared by polymerizing a composition including at least one polymerizable monomer and a charge control agent.

Here, the at least one polymerizable monomer may be selected from a vinyl monomer, a polar monomer having a carboxyl group, a monomer having an unsaturated ester group, and a monomer having a fatty acid group. A specific example of the at least one polymerizable monomer may be the polymerizable monomer described above.

In addition, the polymerizable monomer may be a polymerizable monomer having at least three cross-linkable functional groups, i.e., a cross-linking agent. Nonrestrictive examples of the polymerizable monomer may include trialyl isocyanurate, (di)ethylene glycol di(metha)acrylate, trimethylolpropane triacrylate, trimethylolethylene triacrylate, divinyl pyridine, quinon dioxime, benzoquinone dioxime, p-nitrosophenol, N,N′-m-phenylene-bismaleimide, and the like. In particular, the polymerizable monomer may be multi-functional (metha)acrylates, for example, pentaerythritol triacrylate or trimethylol propanetri(metha)acrylate.

The charge control agent may be preferably selected from the group consisting of a salicylic acid compound containing metals such as zinc or aluminum, boron complexes of bis diphenyl glycolic acid, and silicate. More preferably, dialkyl salicylic acid zinc, boro bis(1,1-diphenyl-1-oxo-acetyl potassium salt), or the like can be used.

Processes of preparing a primarily agglomerated toner which corresponds to a core of the toner according to embodiments of the present general inventive concept and coating latex particles for a shell layer on the first primarily agglomerated toner will now be described in detail.

First, polymer latex particles are prepared by polymerizing a toner composition including the macromonomer and at least one polymerizable monomer as described above. More particularly, while the inside of a reactor is purged with nitrogen gas or the like, a mixture solution of a medium such as distilled deionized water (or a mixture of water and an organic solvent) and the macromonomer is added to the reactor and heated while being stirred. An electrolyte or an inorganic salt such as NaOH or NaCl may be added thereto to adjust ionic strength of the reaction medium. When the temperature inside the reactor reaches a certain level, an initiator, preferably a water-soluble free radical initiator, may be introduced. Then, at least one polymerizable monomer may be added to the reactor using a semi-continuous method with a chain transfer agent. Here, polymerizable monomer may be slowly provided using a starved feeding process to adjust a reaction speed and dispersibility of the solution.

The polymerization may be performed in the range of 6 to 12 hours and the polymerization time is dependent on the reaction temperature and experimental conditions and determined by measuring reaction speed and conversion rate. Polymer latex particles may be prepared by adding additional monomers to adjust durability or other physical properties of the toner after the reaction. Then, the prepared polymer latex particles are agglomerated.

In the present general inventive concept, a wax layer which is coated on the agglomerated polymer latex particles is formed by adding a dispersion obtained by dispersing wax in a mixed solution in which the at least one polymerizable monomer as described above is mixed with a solvent to the reactor in which core particles are formed and additionally adding an initiator, and the like to the reactor. After the formation of the wax layer, at least one polymerizable monomer is additionally added to the reactor to further form a shell layer. Herein, a polymerization inhibitor may further be added in order not to produce new latex particles. In addition, the reaction may be carried out using a starved feeding process in order to well-coat the mixed solution of the polymerizable monomer and the solvent on the core particles.

The wax layer formed on the agglomerated polymer latex particles may be formed by selecting a suitable wax which provides desired properties of a final toner composition. Examples of the wax include polyethylene-based wax, polypropylene-based wax, silicon wax, paraffin-based wax, ester-based was, carbauna wax, and metallocene wax, but are not limited thereto. The melting point of the wax may be in the range of about 50 to about 150° C. Wax constituents are physically attached to the toner particles, but are preferably not covalently bonded with toner particles. Thus, a toner that is fixed at a low fixing temperature on a final image receptor and has excellent final image durability and resistance to abrasion can be provided.

After the latex particles for a core which contains wax are prepared as described above, the latex particles for a core are primarily agglomerated by adding an inorganic salt and a self-dispersable pigment thereto.

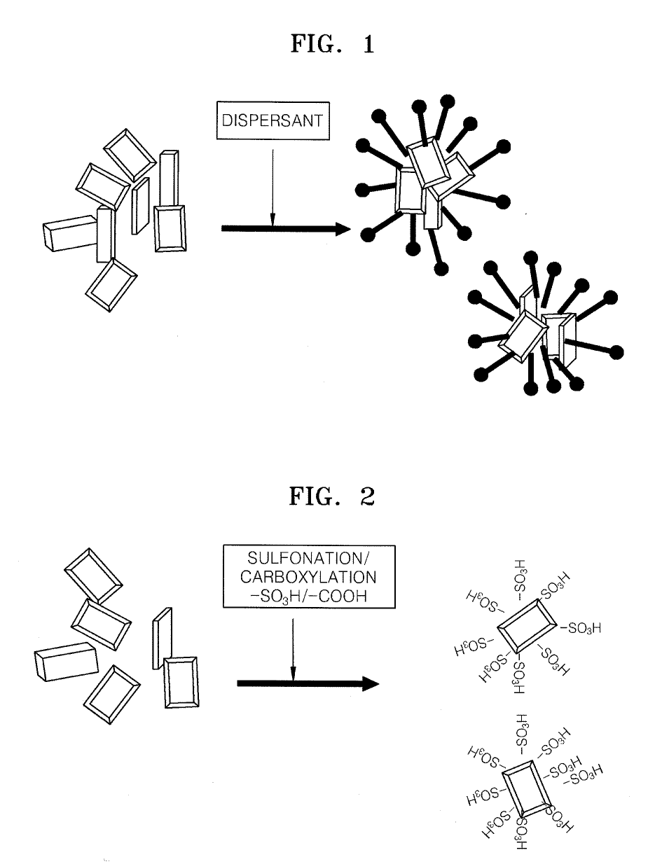

The self-dispersable pigment used herein is a general pigment to which a hydrophilic group such as a carboxyl group, a sulfonic acid group, or the like is attached. Thus, the self-dispersable pigment is well-dispersed in an aqueous solution without using a pigment dispersant. That is, a conventional pigment is water dispersed using a dispersant as illustrated in FIG. 1, however, the self-dispersable pigment used in the present general inventive concept is made by surface treating a general pigment with a hydrophilic group such as a carboxyl group or a sulfonic acid group, thereby being water dispersed without using a dispersant.

The self-dispersable pigment may be a general pigment such as cyan, magenta, yellow or black pigment which is surface-treated with a hydrophilic group. A volume average particle size of the self-dispersable pigment when being water dispersed may be in the range of from 100 to 200 nm.

The self-dispersable pigment may be a commercially-available pigment such as CaboJet 260M, CaboJet 300B, CaboJet 250C, and CaboJet 270Y (manufactured by CABOT Co., Ltd.). However, the self-dispersable pigment may be a pigment prepared by reacting a conventional carbon black with diazonium base, a compound represented by Formula 1 below disclosed in Korean Patent Publication No. 2006-59348 that was previously filed by the present applicant, and a compound represented by Formula 2 below disclosed in Korean Patent Publication No. 2006-29361 that was previously filed by the present applicant, or the like:

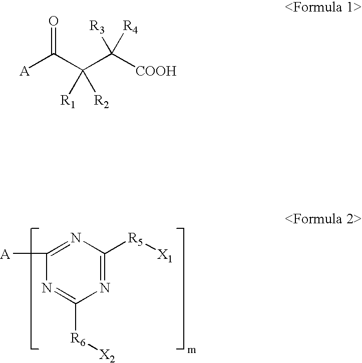

wherein A refers to a pigment residue;

R₁, R₂, R₃, and R₄ are each independently hydrogen, a substituted or unsubstituted C₁-C₂₀ alkyl group, a substituted or unsubstituted C₆-C₂₀ aryl group, a substituted or unsubstituted C₃-C₂₀ heteroalkyl group, or a substituted or unsubstituted C₂-C₁₂ alkenyl group, R₁ and R₄ can form C₂-C₁₅ cyclic or heterocyclic together, and R₂ and R₃ can form a bond;

R₅ and R₆ each independently form a chemical bond, or are each independently a substituted or unsubstituted C₁-C₁₀ alkylene group, a substituted or unsubstituted C₆-C₁₀ arylene group, a substituted or unsubstituted C₂-C₁₀ heteroarylene group, or a substituted or unsubstituted C₄-C₁₀ cycloalkylene group,

X₁ and X₂ are each independently a carboxylic acid group, a salt thereof, a sulfonic acid group, a salt thereof, or an amino group, and

m is an integer of 1 or 2.

In Formulae 1 and 2, the pigment residue A may be any pigment which is conventionally used in a conventional toner composition. Examples of the pigment may include carbon black, graphite, vitreous carbon, activated charcoal, activated carbon, anthraquinone, phthalocyanin blue, phthalocyanin green, diazos, monoazos, pyranthrones, perylene, quinacridone, indigoid pigments, and the like, but are not limited thereto.

The unsubstituted C₁-C₂₀ alkyl group of Formula 1 may be methyl, ethyl, propyl, isobutyl, sec-butyl, pentyl, iso-amyl, hexyl, or the like. At least one hydrogen atom of the unsubstituted C₁-C₂₀ alkyl group may be substituted with a halogen atom, a hydroxyl group, a nitro group, a cyano group, an amino group, an amidino group, hydrazine, hydrazone, a carboxyl group or a salt thereof, a sulfonic acid group or a salt thereof, a phosphoric acid or a salt thereof, a C₁-C₂₀ alkyl group, a C₁-C₂₀ alkenyl group, a C₁-C₂₀ alkynyl group, a C₁-C₂₀ heteroalkyl group, a C₆-C₂₀ aryl group, a C₆-C₂₀ arylalkyl group, a C₆-C₂₀ heteroaryl group, or a C₆-C₂₀ heteroarylalkyl group.

The aryl group used herein refers to a C₆-C₂₀ aromatic system containing at least one ring. Herein, the rings can be attached to each other using a pedant method or fused with each other. The term “aryl” refers to an aromatic radical, including phenyl, naphthyl, tetrahydronaphthyl, or the like. The aryl group may have a substituent such as haloalkylene, nitro, cyano, alkoxy, and lower alkylamino. At least one hydrogen atom of the aryl group may be substituted with the same substituent as in alkyl group described above.

The heteroaryl group refers to a monovalent monocyclic or bicyclic aromatic bivalent organic compound which contains 1, 2 or 3 hetero atoms selected from the group consisting of N, O, P, and S and has 6 to 20 carbon atoms. At least one hydrogen atom of the heteroaryl group may be substituted with the same substituent as in the alkyl group described above.

The arylalkyl group refers to a substituent in which an aryl or heteroaryl group as described above is included in the ends of a C₂-C₁₄ alkyl group. Herein, at least one hydrogen atom in the alkyl, aryl or heteroaryl group can be substituted with the same substituent as in the alkyl group described above.

The self-dispersable pigment of Formula 1 may be prepared by a method including reacting a ring anhydride represented by Formula 3 below with a pigment in the presence of a Lewis acid:

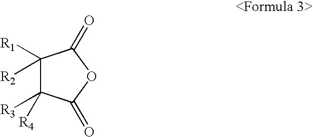

wherein R₁, R₂, R₃, and R₄ are the same as defined in Formula 1.

In Formula 2, particularly, the substituted or unsubstituted C₁-C₁₀ alkylene group may be an ethylene group, or the like, the substituted or unsubstituted C₆-C₁₀ arylene group may be a phenylene group, or the like, the substituted or unsubstituted C₂-C₁₀ heteroarylene group may be a thiazolylene group, or the like, and the substituted or unsubstituted C₄-C₁₀ cycloalkylene group may be a cyclohexylene group, or the like.

The self-dispersable pigment of Formula 2 may be prepared as follows. When a conventional pigment is reacted with a triazine compound such as cyanuric chloride (for example, 2,4,6-Trichloro-1, 3, 5-triazine), the pigment is generally bound to the triazine compound through an active site contained in the pigment (an amino group, a hydroxyl group, or the like). Then, a substituent of the triazine ring contained in the obtained compound is replaced with a hydrophilic functional group (or ionic functional group) such as a carboxyl group, a salt thereof, a sulfonic acid group, or a salt thereof.

The amount of the self-dispersable pigment may be preferably 0.1 to 20 parts by weight based on 100 parts by weight of the polymerizable monomer. The amount of the self-dispersable pigment should be sufficient to color the toner. However, when the amount of the self-dispersable pigment is less than 0.1 parts by weight based on 100 parts by weight of the polymerizable monomer, the coloring effect is not sufficient. On the other hand, when the amount of the self-dispersable pigment is greater than 20 parts by weight based on 100 parts by weight of the polymerizable monomer, the manufacture costs of the toner increase, and thus sufficient frictional charge amount cannot be obtained.

In addition, the primarily agglomerated toner is prepared by adding an inorganic salt to a mixed solution of the latex particles for a core and the self-dispersable pigment dispersion, leading to agglomerate the resultant. That is, the size of the primarily agglomerated toner increases due to increased ionic strength by the addition of the inorganic salt and collisions between the particles.

Particularly, when a concentration of the inorganic salt is heavier than a critical coagulation concentration (CCC), an electrostatic repulsive force between latex particles is offset, and thus agglomeration rapidly occurs due to Brownian motion of the polymer latex particles. When a concentration of the inorganic salt is lower than the CCC, agglomeration speed becomes slow, and thus agglomeration of the polymer latex particles can be controlled. The inorganic salt used may be at least one selected from the group consisting of NaCl, MgCl₂.8H₂0, [Al₂(OH)ₙCl₆₋ₙ]ₘ where 1≦n≦5 and 1≦m≦10, and Al₂(SO₄)₃.18H₂O, but the present general inventive concept is not limited thereto.

Subsequently, toner particles with a desired size and shape are obtained by coating the previously prepared latex particles for a shell layer on the prepared primarily agglomerated toner. Then, the toner particles are filtered to be separated and then dried. The dried toner particles are externally added with silica, or the like, and charged electric charge amount thereof, and the like are adjusted to obtain final dry toner.

Herein, the latex particles for a shell layer is prepared in a method similar to the method of preparing polymer latex described above, using a composition comprising the at least one polymerizable monomer and the charge control agent. That is, while the inside of a reactor is purged with nitrogen gas or the like, a mixture solution of a medium such as distilled deionized water (or a mixture of water and an organic solvent) and the macromonomer is added to the reactor and heated while being stirred. An electrolyte or an inorganic salt such as NaOH or NaCl may be added thereto to adjust ionic strength of the reaction medium. When the temperature inside the reactor reaches a certain level, an initiator, preferably a water-soluble free radical initiator, may be introduced. Then, at least one polymerizable monomer and a charge control agent are added to the reactor using a semi-continuous method, preferably with a chain transfer agent. Here, polymerizable monomers may be slowly provided using a starved feeding process to adjust a reaction speed and dispersibility of the solution. The polymerization may be performed in the range of 4 to 8 hours and the polymerization time is dependent on the reaction temperature and experimental conditions and is determined by measuring reaction speed and conversion rate.

Since at least one operation of the preparing of latex particles for a core, the preparing of primarily agglomerated toner, and the coating of the latex particles for a shell layer on the primarily agglomerated toner is carried out without a surfactant and a pigment dispersant as well, washing processes may be minimized in the separation and filtration of the prepared toner particles. Manufacturing costs for the toner may be reduced by minimizing the number of washing processes, and the manufacturing process is more environmentally friendly by decreasing the amount of wastewater generated. Further, problems such as high sensitivity in high humidity, low frictional charge, reduced dielectric property, and weak toner flow may be removed since the surfactant is not used. Also, the storage stability of the toner can be significantly improved.

The toner composition according to an embodiment of the present general inventive concept may further include at least one agent selected from an initiator, a chain transfer agent, a release agent, and a charge control agent.

In the preparation process, radicals may be created by the initiator in the toner composition, and the radicals may react with the polymerizable monomer. The radicals may form a copolymer by reacting with the polymerizable monomer and reactive functional groups of the macromonomer.

Examples of the initiator for radical polymerization include persulfate salts such as potassium persulfate, and ammonium persulfate; azo compounds such as 4,4-azobis(4-cyano valeric acid), dimethyl-2,2′-azobis(2-methyl propionate), 2,2-azobis(2-amidinopropane)dihydrochloride, 2,2-azobis-2-methyl-N-1, 1-bis(hydroxymethyl)-2-hydroxyethylpropioamide, 2,2′-azobis(2,4-dimethyl valeronitrile), 2,2′-azobis isobutyronitrile, and 1,1′-azobis(1-cyclohexanecarbonitrile); and peroxides such as methyl ethyl peroxide, di-t-butylperoxide, acetyl peroxide, dicumyl peroxide, lauroyl peroxide, benzoyl peroxide, t-butylperoxy-2-ethyl hexanoate, di-isopropyl peroxydicarbonate, and di-t-butylperoxy isophthalate. Also, an oxidization-reduction initiator in which the polymerization initiator and a reduction agent are combined may be used.

A chain transfer agent is a material that converts a type of chain carrier in a chain reaction. A new chain has much less activity than that of a previous chain. Using the chain transfer agent, the polymerization degree of the monomer can be reduced and new chains can be initiated. In addition, a molecular weight distribution can be adjusted using the chain transfer agent.

Examples of the chain transfer agent include sulfur containing compounds such as dodecanthiol, thioglycolic acid, thioacetic acid, and mercaptoethanol; phosphorous acid compounds such as phosphorous acid and sodium phosphite; hypophosphorous acid compounds such as hypophosphorous acid and sodium hypophosphite; and alcohols such as methyl alcohol, ethyl alcohol, isopropyl alcohol, and n-butyl alcohol, but are not limited thereto.

The release agent can be used to protect a photoreceptor and prevent deterioration of developing, thereby obtaining a high quality image. A release agent according to an embodiment of the present general inventive concept may be a high purity solid fatty acid ester material. Examples of the release agent include low molecular weight polyolefins such as low molecular weight polyethylene, low molecular weight polypropylene, and low molecular weight polybutylene; paraffin wax; and multi-functional ester compounds. The release agent used in the present general inventive concept may be a multifunctional ester compound composed of alcohol having at least three functional groups and carboxylic acid.

The polyhydric alcohol having at least three functional groups may be aliphatic alcohols such as glycerin, pentaerythritol, and pentaglycerol; alicyclic alcohols such as chloroglycitol, quersitol, and inositol; aromatic alcohols such as tris(hydroxymethyl)benzene; sugars such as D-erythrose, L-arabinose, D-mannose, D-galactose, D-fructose, L-lamunose, sucrose, maltose, and lactose; or sugar-alcohols such as erythrite, D-trate, L-arabite, adnit, and chissirite.

The carboxylic acid may be aliphatic carboxylic acids such as acetic acid, butyric acid, caproic acid, enantate, caprylic acid, pelargonic acid, capric acid, undecanoic acid, lauric acid, myristic acid, stearic acid, magaric acid, arachidic acid, cerotic acid, sorbic acid, linoleic acid, linolenic acid, behenic acid, tetrolic acid,; alicyclic carboxylic acids such as cyclohexanecarboxylic acid, hexahydroisophthalic acid, hexahydroterephthalic acid, and 3,4,5,6-tetrahydrophthalic acid; or aromatic carboxylic acids such as benzoic acid, cumic acid, phthalic acid, isophthalic acid, terephthalic acid, trimesic acid, trimellitic acid, and hemimellitic acid.

The charge control agent may be preferably selected from the group consisting of a salicylic acid compound containing metals such as zinc or aluminum, boron complexes of bis diphenyl glycolic acid, and silicate. More preferably, dialkyl salicylic acid zinc, boro bis(1,1-diphenyl-1-oxo-acetyl potassium salt), or the like can be used.

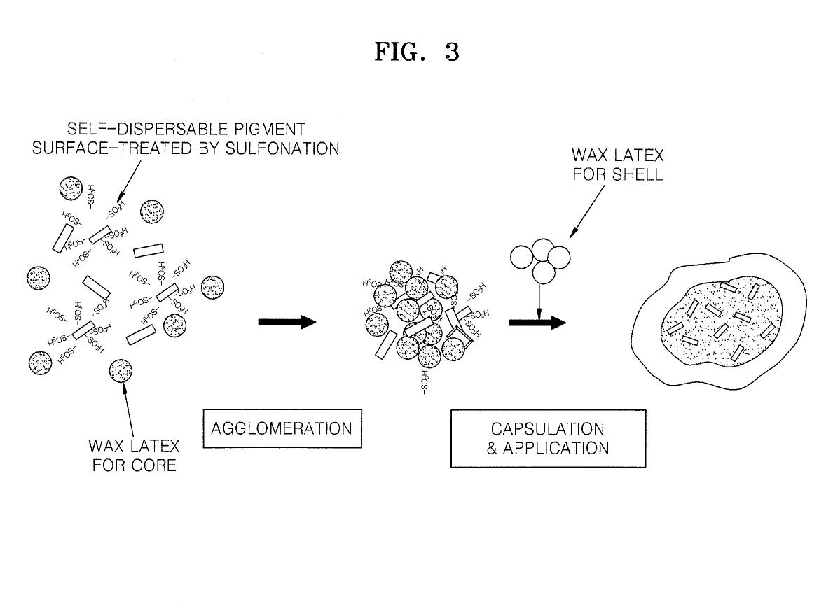

FIG. 3 is a schematic view illustrating a method of preparing toner according to an embodiment of the present general inventive concept. Referring to FIG. 3, latex particles for a core made from a polymerizable monomer, a macromonomer, a wax and a dispersable pigment are agglomerated, and then coated with latex particles for a shell layer and melted to prepare toner particles.

The present general inventive concept also provides a toner prepared by the method including: preparing latex particles for a core which contain wax by polymerizing a toner composition including at least one polymerizable monomer and a macromonomer having a hydrophilic group, a hydrophobic group, and at least one reactive functional group; mixing the latex particles for a core with a self-dispersable pigment dispersion and adding an inorganic salt thereto to prepare a primarily agglomerated toner; and coating latex particles for a shell layer on the primarily agglomerated toner.

Herein, at least one operation of the preparing of the latex particles for a core, the preparing of the primarily agglomerated toner and the coating of the latex particles for a shell layer on the primarily agglomerated toner may be carried out in the absence of a surfactant. The detailed description thereof is the same as described above. A volume average particle diameter of the prepared toner particles may be in the range of from 3 to 20 μm, and preferably in the range of from 5 to 8 μm.

A weight average molecular weight of the macromonomer may be in the range of 100 to 100,000, and preferably 1,000 to 10,000. The macromonomer may be a material selected from the group consisting of polyethylene glycol (PEG)-methacrylate, polyethylene glycol (PEG)-ethyl ether methacrylate, polyethylene glycol (PEG)-dimethacrylate, polyethylene glycol (PEG)-modified urethane, polyethylene glycol (PEG)-modified polyester, polyacrylamide (PAM), polyethylene glycol (PEG)-hydroxyethyl methacrylate, hexafunctional polyester acrylate, dendritic polyester acrylate, carboxy polyester acrylate, fatty acid modified acrylate, and polyester methacrylate, but is not limited thereto.

The present general inventive concept also provides a method of forming an image, the method comprising attaching a toner to a surface of a photoreceptor on which an electrostatic latent image is formed to form a visualized image and transferring the visualized image to a transfer medium, wherein the toner is prepared using a method including: preparing latex particles for a core which contain wax by polymerizing a toner composition including at least one polymerizable monomer and a macromonomer having a hydrophilic group, a hydrophobic group, at least one reactive functional group; mixing the latex particles for a core with a self-dispersable pigment dispersion and adding an inorganic salt thereto to prepare a primarily agglomerated toner; and coating latex particles for a shell layer on the primarily agglomerated toner.

A representative electrophotographic image forming process includes a series of processes of forming images on a receptor including charging, exposure to light, developing, transferring, fixing, cleaning, and antistatic process operations.

In the charging process, a surface of a photoreceptor is charged with negative or positive charges, whichever is desired, by a corona or a charge roller. In the light exposing process, an optical system, conventionally a laser scanner or an array of diodes, selectively discharges the charged surface of the photoreceptor in an imagewise manner corresponding to a final visual image formed on a final image receptor to form a latent image. Electromagnetic radiation, which can be referred to as “light” may be infrared radiation, visible light, or ultraviolet radiation.

In the developing process, appropriate polar toner particles generally contact the latent image of the photoreceptor, and conventionally, an electrically-biased developer having identical potential polarity to the toner polarity is used. The toner particles move to the photoreceptor and are selectively attached to the latent image by electrostatic electricity, and form a toner image on the photoreceptor.

In the transferring process, the toner image is transferred to the final image receptor from the photoreceptor, and sometimes, an intermediate transferring element is used when transferring the toner image from the photoreceptor to aid the transfer of the toner image to the final image receptor.

In the fixing process, the toner image of the final image receptor is heated and the toner particles thereof are softened or melted, thereby fixing the toner image to the final image receptor. Another way of fixing is to fix toner on the final image receptor under high pressure with or without the application of heat.

In the cleaning process, residual toner remaining on the photoreceptor is removed.

Finally, in the antistatic process, charges of the photoreceptor are exposed to light of a predetermined wavelength band and are reduced to be substantially uniform and of low value, and thus the residue of the original latent image is removed and the photoreceptor is prepared for a next image forming cycle.

Embodiments of the present general inventive concept also provide an image forming apparatus comprising: an organic photoreceptor; a unit to charge a surface of the organic photoreceptor; an image forming unit that forms an electrostatic latent image on a surface of the organic photoreceptor; a unit to receive toner; a toner image developing unit that develops the electrostatic latent image on the surface of the organic photoreceptor by supplying the toner; and a toner transferring unit that transfers the toner image to a transfer medium from the surface of the organic photoreceptor, wherein the toner is prepared using a method comprising: preparing latex particles for a core which contain wax by polymerizing a toner composition including at least one polymerizable monomer and a macromonomer having a hydrophilic group, a hydrophobic group, and at least one reactive functional group; mixing the latex particles for a core with a self-dispersable pigment dispersion and adding an inorganic salt thereto to prepare a primarily agglomerated toner; and coating latex particles for a shell layer on the primarily agglomerated toner.

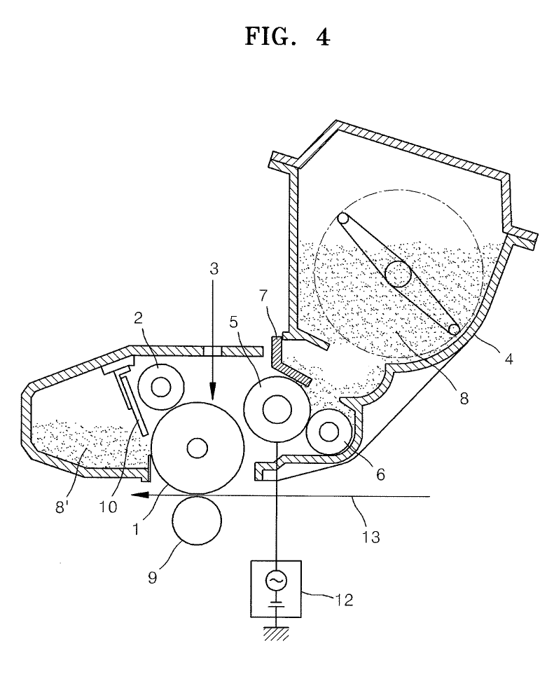

FIG. 4 illustrates a schematic diagram of a non-contact developing type image forming apparatus using a toner prepared using the method according to an embodiment of the present general inventive concept. The operation principle thereof is as follows.

A developer 8, which is a nonmagnetic one-component developer of a developing unit 4, is supplied to a developing roller 5 through a feeding roller 6 formed of an elastic material such as a polyurethane foam or sponge. The developer 8 supplied to the developing roller 5 reaches a contact point between a developer regulation blade 7 and the developing roller 5 as the developing roller 5 rotates. The developer regulation blade 7 is formed of an elastic material such as metal, rubber, or the like. When the developer 8 passes the contact point between the developer regulation blade 7 and the developing roller 5, the developer 8 is smoothed to form a thin layer that is sufficiently charged. The developing roller 5 transfers the thin layer of the developer 8 to a developing domain where the thin layer of the developer 8 is developed on the electrostatic latent image of a photoreceptor 1, which is a latent image carrier. The electrostatic latent image is formed by scanning light 3 onto the photoreceptor 1.

The developing roller 5 and the photoreceptor 1 face each other with a constant distant therebetween. The developing roller 5 rotates counterclockwise and the photoreceptor 1 rotates clockwise.

The developer 8 that becomes transferred to the developing domain of the photoreceptor 1 forms a toner image by developing an electrostatic latent image on the photoreceptor 1 according to the intensity of the electric charge generated due to a difference between an AC voltage superposed with a DC voltage applied to the developing roller 5 and a latent image potential of the photoreceptor 1 that is charged by a charging unit 2.

The developer 8 developed on the photoreceptor 1 is transferred toward a transferring means 9 as the photoreceptor 1 rotates. More specifically, the developer 8 developed on the photoreceptor 1 is transferred to a sheet of printing paper 13 by a transferring means 9 in the form of corona discharge or a roller to which a high voltage having inverse polarity of the developer 8 is applied as the printing paper 13 passes through the developer 8 developed on the photoreceptor 1, and thus an image is formed.

The image transferred to the printing paper 13 passes through a fusing device (not shown) that provides high temperature and high pressure, and the image is fused to the printing paper 13 as the developer 8 is fused to the printing paper 13. Meanwhile, developer 8′ remaining on the developing roller 5 and which is not developed is transferred back to the feeding roller 6 contacting the developing roller 5. The remaining developer 8′ that is undeveloped on the photoreceptor 1 is collected by a cleaning blade 10. The above processes are repeated.

Embodiments of the present general inventive concept will be described in more detail with reference to the examples below, but is not limited thereto. The following examples are for illustrative purposes only and are not intended to limit the scope of the general inventive concept.

### Example 1

### Preparation of Latex Particles for Core

While the inside of a 3 L reactor was purged with nitrogen gas, a mixture solution of 1,500 g of distilled deionized water and 2.7 g of poly(ethylene glycol)-ethyl ether methacrylate (PEG-EEM, Aldrich) was added to the reactor and heated at 82° C. while being stirred at 250 rpm. 350 g of a monomer mixture of styrene, n-butyl acrylate, and methacrylic acid in a weight ratio of 68:28:4, 5.1 g of 1-dodecanethiol as a chain transfer agent, and 20 g of ester wax were melted at 60° C., and dispersed using ultrasonic waves for 5 minutes, and then added to the reactor, the temperature of which was maintained at 82° C. 25 g of potassium persulfate (KPS) dissolved in 764 g of deionized water as a water soluble free radical initiator was added to the reactor. The reaction was performed for 2 hours. Then, 220 g of a monomer mixture of styrene, n-butyl acrylate, and methacrylic acid in a weight ratio of 66:30:4 and 3.3 g of 1-dodecanethiol as a chain transfer agent were dripped in the reactor over 1 hour, and then the reaction was performed for 4 to 6 hours. After the reaction was terminated, the resultant was cooled naturally while being stirred. A particle size of the toner latex was 300 to 350 nm, and a conversion rate was almost 100%. Upon DSC measurement, T_{g} of the latex particles was 46° C., and the molecular weight M_{w} thereof was 30,000 as a result of GPC measurement.

### Preparation of Latex Particles for Shell Layer

While the inside of a 3 L reactor was purged with nitrogen gas, a mixture solution of 1,700 g of distilled deionized water and 22.4 g of poly(ethylene glycol)-ethyl ether methacrylate (PEG-EEM, Aldrich) was added to the reactor and heated while being stirred at 450 rpm. When the inside temperature of the reactor reached 82° C., 11.2 g of potassium persulfate (KPS) dissolved in 400 g of deionized water as a water soluble free radical initiator was added in the reactor. Then, 560 g of a monomer mixture of styrene, n-butyl acrylate, and methacrylic acid in a weight ratio of 71:24:5 and 8.7 g of 1-dodecanethiol as a chain transfer agent were added to the reactor using a starved-feeding method. The reaction time was in the range of 4 to 6 hours, and after the reaction was terminated, the resultant was cooled naturally while being stirred. A particle size of the toner latex was 100 to 400 nm, and a conversion rate was almost 100%. Upon DSC measurement, T_{g} of the latex particles was 55° C., and the molecular weight M_{w} thereof was 55,000 as a result of GPC measurement.

### Agglomeration and Preparation of Toner

316 g of deionized water and 307 g of copolymer latex, i.e., (styrene)-(n-butyl acrylate)-(methacrylic acid)-(polyethylene glycol-ethylether methacylate) containing wax, prepared by the method of preparing a latex for a core described above were added to a 1 L reactor and stirred at 350 rpm. While the mixture was stirred, 63 g of a self-dispersable magenta pigment dispersion (CaboJet 260M, solid content 10%, manufacturer; Cabot) was added in the reactor. The pH of the mixture was adjusted at 11, and then a cohesive agent (NaCl, MgCl₂.8H₂O, [Al₂(OH)ₙCl₆₋ₙ]ₘ) was added in the reactor. Then, the temperature of the reactor was raised by 95° C. by heating at a speed of 1-2° C./min. The reaction was performed at 95° C. for 2 to 4 hours, and then NaCl was added in the reactor. After the reaction was performed for 2 hours, 150 g of a latex prepared to form a shell layer was added in the reactor, the pH of the mixture was adjusted at 11, and then the reaction was performed until a toner with a desired size and shape was obtained. After the reaction, the temperature of the toner was cooled down below T_{g}, and then the toner particles were filtered to be separated and then dried. The prepared toner was in the form of between potato and sphere, and had a volume average particle diameter of about 6.5 μm.

### Example 2

A toner was prepared in the same manner as in Example 1, except that 41 g of a self-dispersable carbon black pigment water dispersion (CaboJet 300B, 10% solid, manufacturer: Cabot) was used instead of the magenta pigment. The prepared toner was in the form of between potato and sphere, and had a volume average particle diameter of about 6.2 μm.

### Example 3

A toner was prepared in the same manner as in Example 1, except that 63 g of a self-dispersable cyan pigment water dispersion (CaboJet 250C, 10% solid, manufacturer: Cabot) was used instead of the magenta pigment. The prepared toner was in the form of between potato and sphere, and had a volume average particle diameter of about 6.7 μm.

### Example 4

A toner was prepared in the same manner as in Example 1, except that 63 g of a self-dispersable yellow pigment water dispersion (CaboJet 270Y, 10% solid, manufacturer: Cabot) was used instead of the magenta pigment. The prepared toner was in the form of between potato and sphere, and had a volume average particle diameter of about 6.0 μm.

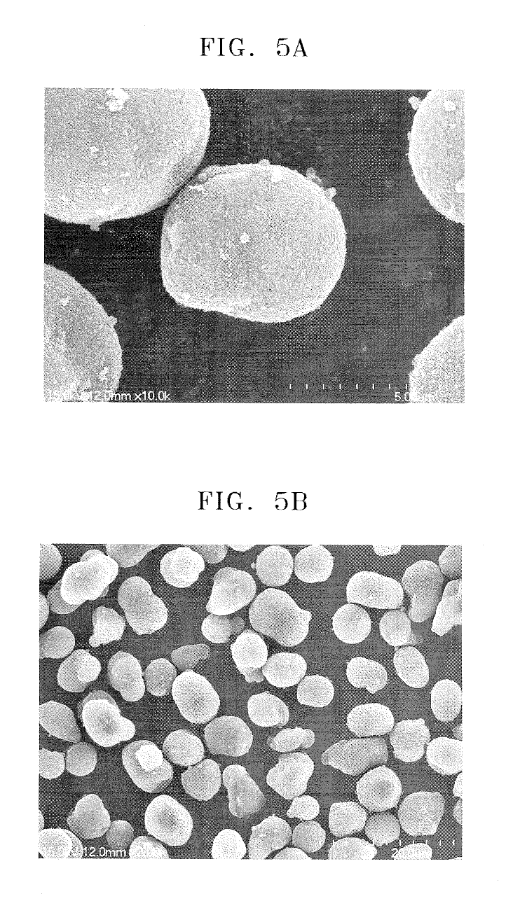

FIGS. 5A and 5B are scanning electron microscopy (SEM) images of toner particles prepared according to Example 1, at ×10,000 magnification and ×2,000 magnification, respectively.

### Comparative Example 1

### Preparation of Latex Particles for Core

While the inside of a 3 L reactor was purged with nitrogen gas, a mixture solution of 1,500 g of distilled deionized water and 2.7 g of poly(ethylene glycol)-ethyl ether methacrylate (PEG-EEM, Aldrich) was added to the reactor and heated at 82□ while being stirred at 250 rpm. 350 g of a monomer mixture of styrene, n-butyl acrylate, and methacrylic acid in a weight ratio of 64:32:4, 5.1 g of 1-dodecanethiol as a chain transfer agent, and 20 g of ester wax were melted at 60□, and dispersed using ultrasonic waves for 5 minutes, and then added to the reactor, the temperature of which was maintained at 82° C. 25 g of potassium persulfate (KPS) dissolved in 764 g of deionized water as a water soluble free radical initiator was added to the reactor. The reaction was performed for 2 hours. Then, 220 g of a monomer mixture of styrene, n-butyl acrylate, and methacrylic acid in a weight ratio of 63:33:4 and 3.3 g of 1-dodecanethiol as a chain transfer agent were dripped to the reactor over 1 hour, and then the reaction was performed for 4 to 6 hours. After the reaction was terminated, the resultant was cooled naturally while being stirred. A particle size of the toner latex was 300 to 350 nm, and a conversion rate was almost 100%. Upon DSC measurement, T_{g} of the latex particles was 43° C., and the molecular weight M_{w} thereof was 37,000 as a result of GPC measurement.

### Preparation of Latex Particles for Shell Layer

While the inside of a 3 L reactor was purged with nitrogen gas, a mixture solution of 1,700 g of distilled deionized water and 22.4 g of poly(ethylene glycol)-ethyl ether methacrylate (PEG-EEM, Aldrich) was added in the reactor and heated while being stirred at 450 rpm. When the inside temperature of the reactor reached 82° C., 15.2 g of potassium persulfate (KPS) dissolved in 400 g of deionized water as a water soluble free radical initiator was added to the reactor. Then, 560 g of a monomer mixture of styrene, n-butyl acrylate, and methacrylic acid in a weight ratio of 75:20:5 and 8.7 g of 1-dodecanethiol as a chain transfer agent were added to the reactor using a starved-feeding method. The reaction time was in the range of 4 to 6 hours, and after the reaction was terminated, the resultant was cooled naturally while being stirred. A particle size of the toner latex was 100 to 400 nm, and a conversion rate was almost 100%. As a result of DSC measurement, T_{g} of the latex particles was 61° C., and the molecular weight M_{w} thereof was 43,000 as a result of GPC measurement.

### Agglomeration and Preparation of Toner

316 g of deionized water and 307 g of latex particles for a core prepared according to the process described above were added to a 1 L reactor and stirred at 350 rpm. While the mixture was stirred, 35 g (18% of solid content) of a magenta pigment dispersion (R122, Dainichi-seika) was added thereto. The pH of the mixture was adjusted at 11, 20 g of MgCl₂ was added in the reactor, and the reactor was gradually heated up to 95° C. The mixture was reacted at 95° C. for 2 hours, and reacted with NaCl for an additional 2 hours. 150 g of latex particles for a shell layer was added thereto, and then the mixture was reacted for 6 hours. Then, the mixture was cooled down below T_{g}, and filtered to separate toner particles and then dried. The prepared toner was in the form of between potato and sphere, and had a volume average particle diameter of about 6.5 μm.

### Comparative Example 2

A toner was prepared in the same manner as in Comparative Example 1, except that 23 g of a carbon black pigment dispersion (Mogul-L, Cabot) was used instead of the magenta pigment. The prepared toner was in the form of between potato and sphere, and had a volume average particle diameter of about 6.9 μm.

### External Addition of Toner

0.5 parts by weight of NX-90 (Nippon Aerosil), 1.0 part by weight of Rx-200 (Nippon Aerosil), and 0.5 parts by weight of SW-100 (Titan Kogyo) per 100 parts by weight of toner particles were added to the toners prepared by Examples and Comparative Examples, and then stirred at 3,000 rpm for 5 minutes using a mixer (Piccolo, Kawata).

### Storage Evaluation of Toner

100 g of the toner treated by external addition was added to a developer, and then stored in an oven with a constant temperature and humidity as follows in a package state.

High temperature storage test −50° C., 80% RH (Relative Humidity) 48 hr storage

H/H (High temperature/High humidity) test

30° C., 80˜90% RH 24 hr storage

After the toner was stored under the conditions described above, 100% of an image was printed out. Then, the charge amount (Q/M) of the image was measured and image defects were evaluated.

Evaluation standard

### ∘: Good Image, No-Background

### Δ: Bad Image, No-Background

X: Image background generation

### Evaluation Result of Toner

After high temperature storage for 48 hr (50° C., 80% RH)

| | 1K | | | | | | | |
|---|---|---|---|---|---|---|---|---|
| | (1000 sheets) | | 2K | | 3K | | 8K | |
| | Q/M | BG | Q/M | BG | Q/M | BG | Q/M | BG |
| Example 1 | −35 μC/g | ◯ | −34 μC/g | ◯ | −34 μC/g | ◯ | −32 μC/g | ◯ |
| Example 2 | −31 μC/g | ◯ | −30 μC/g | ◯ | −29 μC/g | ◯ | −28 μC/g | ◯ |
| Comparative | −15 μC/g | Δ | −18 μC/g | X | −16 μC/g | X | −20 μC/g | X |
| Example 1 | | | | | | | | |
| Comparative | −14 μC/g | Δ | −16 μC/g | X | −17 μC/g | X | −20 μC/g | X |
| Example 2 | | | | | | | | |

After H/H storage for 24 hr (30° C./80˜90% RH)

| | 1K | | | | | | | |
|---|---|---|---|---|---|---|---|---|
| | (1000 sheets) | | 2K | | 3K | | 8K | |
| | Q/M | BG | Q/M | BG | Q/M | BG | Q/M | BG |
| Example 1 | −36 μC/g | ◯ | −35 μC/g | ◯ | −35 μC/g | ◯ | −34 μC/g | ◯ |
| Example 2 | −33 μC/g | ◯ | −32 μC/g | ◯ | −32 μC/g | ◯ | −30 μC/g | ◯ |
| Comparative | −16 μC/g | Δ | −18 μC/g | Δ | −17 μC/g | Δ | −20 μC/g | X |
| Example 1 | | | | | | | | |
| Comparative | −15 μC/g | Δ | −16 μC/g | Δ | −16 μC/g | Δ | −20 μC/g | X |
| Example 2 | | | | | | | | |

According to the present general inventive concept, pigments are uniformly dispersed even without using a dispersant, and the toners have excellent charge properties, are uniformly transferred, and have excellent resistance to environment. In addition, the amount of washing water required for a washing process is reduced, and thus the producing costs can be reduced when a toner is prepared, and a polymerizable toner having excellent characteristics even in a high humidity environment can be prepared.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of preparing toner, comprising:
preparing latex particles for a core which contain wax by polymerizing a toner composition comprising at least one polymerizable monomer and a macromonomer having a hydrophilic group, a hydrophobic group, and at least one reactive functional group;
mixing the latex particles for a core with a self-dispersable pigment dispersion and adding an inorganic salt thereto to prepare a primarily agglomerated toner; and
coating latex particles for a shell on the primarily agglomerated toner.

2. The method of claim 1, wherein the preparing of the latex particles for a core which contain wax comprises:
preparing polymer latex particles by polymerizing a toner composition which comprises at least one polymerizable monomer and a macromonomer having a hydrophilic group, a hydrophobic group, and at least one reactive functional group;
agglomerating the polymer latex particles; and
forming a wax layer which comprises at least one polymerizable monomer, and coats the agglomerated particles using a dispersion in which wax is dispersed.

3. The method of claim 1, wherein the self-dispersable pigment contains a sulfonic acid group or a carboxyl group on the surface thereof.

4. The method of claim 1, wherein the self-dispersable pigment is a compound represented by Formula 1 or 2 below: 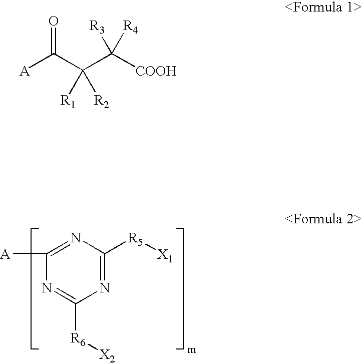
wherein A refers to a pigment residue;
R1, R2, R3, and R4 are each independently hydrogen, a substituted or unsubstituted C1-C20 alkyl group, a substituted or unsubstituted C6-C20 aryl group, a substituted or unsubstituted C3-C20 heteroalkyl group, or a substituted or unsubstituted C2-C12 alkenyl group, R1 and R4 can form C2-C15 cyclic or heterocyclic together, and R2 and R3 can form a bond;
R5 and R6 each independently form a chemical bond, or are each independently a substituted or unsubstituted C1-C10 alkylene group, a substituted or unsubstituted C6-C10 arylene group, a substituted or unsubstituted C2-C10 heteroarylene group, or a substituted or unsubstituted C4-C10 cycloalkylene group,
X1 and X2 are each independently a carboxylic acid group, a salt thereof, a sulfonic acid group, a salt thereof, or an amino group, and
m is an integer of 1 or 2.

5. The method of claim 1, wherein the macromonomer comprises one material selected from the group consisting of polyethylene glycol (PEG)-methacrylate, polyethylene glycol (PEG)-ethyl ether methacrylate, polyethylene glycol (PEG)-dimethacrylate, polyethylene glycol (PEG)-modified urethane, polyethylene glycol (PEG)-modified polyester, polyacrylamide (PAM), polyethylene glycol (PEG)-hydroxyethyl methacrylate, hexafunctional polyester acrylate, dendritic polyester acrylate, carboxy polyester acrylate, fatty acid modified epoxy acrylate, and polyester methacrylate.

6. The method of claim 1, wherein the toner composition comprises approximately 0.1 to 10 parts by weight of an amphiphilic macromonomer based on 100 parts by weight of a polymerizable monomer.

7. The method of claim 2, further comprising:
forming a shell layer by additionally adding at least one polymerizable monomer after the forming of the wax layer.

8. The method of claim 1, wherein the polymerizable monomer comprises at least one monomer selected from the group consisting of a vinyl monomer, a polar monomer having a carboxyl group, a monomer having an unsaturated ester group, and a monomer having a fatty acid group.

9. The method of claim 1, wherein the inorganic salt comprises at least one selected from the group consisting of NaCl, MgCl2.8H20, [Al2(OH)nCl6-n]m where 1≦n≦5 and 1≦m≦10, Al2(SO4)3.18H2O.

10. The method of claim 2, wherein a weight average molecular weight of the macromonomer is between 100 to 100,000.

11. The method of claim 10, wherein a weight average molecular weight of the macromonomer is between 1,000 and 10,000.

12. The method of claim 1, wherein the polymerizable monomer comprises at least one monomer selected from the group consisting of styrene-based monomers such as styrene, vinyl toluene, and α-methyl styrene; acrylic acid or methacrylic acid; derivatives of (metha)acrylates such as methyl acrylate, ethyl acrylate, propyl acrylate, butyl acrylate, 2-ethylhexyl acrylate, dimethylamino ethyl acrylate, methyl methacrylate, ethyl methacrylate, propyl methacrylate, butyl methacrylate, 2-ethylhexyl methacrylate, dimethylaminoethyl methacrylate, acrylonitrile, methacrylonitrile, acrylamide, and metacryl amide; ethylenically unsaturated monoolefins such as ethylene, propylene, and butylenes; halogenized vinyls such as vinyl chloride, vinylidene chloride, and vinyl fluoride; vinyl esters such as vinyl acetate, and vinyl propionate; vinyl ethers such as vinyl methyl ether, and vinyl ethyl ether; vinyl ketones such as vinyl methyl ketone, and methyl isoprophenyl ketone; and nitrogen-containing vinyl compounds such as 2-vinylpyridine, 4-vinylpyridine, and N-vinyl pyrrolidone.

13. The method of claim 4, wherein the self-dispersable pigment of Formula 1 is prepared by reacting a ring anhydride represented by Formula 3 below with a pigment in the presence of a Lewis acid: 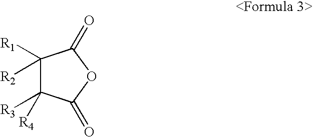
wherein R₁, R₂, R₃, and R₄ are the same as defined in Formula 1.

14. A toner prepared by the preparation method according to the following process:
preparing latex particles for a core which contain wax by polymerizing a toner composition comprising at least one polymerizable monomer and a macromonomer having a hydrophilic group, a hydrophobic group, and at least one reactive functional group;
mixing the latex particles for a core with a self-dispersable pigment dispersion and adding an inorganic salt thereto to prepare a primarily agglomerated toner; and
coating latex particles for a shell on the primarily agglomerated toner.

15. A method of forming an image, comprising:
attaching a toner to a surface of a photoreceptor on which an electrostatic latent image is formed to form a visualized image; and
transferring the visualized image to a transfer medium, wherein the toner is formed by the process of preparing latex particles for a core which contain wax by polymerizing a toner composition comprising at least one polymerizable monomer and a macromonomer having a hydrophilic group, a hydrophobic group, and at least one reactive functional group, mixing the latex particles for a core with a self-dispersable pigment dispersion and adding an inorganic salt thereto to prepare a primarily agglomerated toner, and coating latex particles for a shell on the primarily agglomerated toner.

16. An image forming apparatus comprising:
an organic photoreceptor;
a unit to charge a surface of the organic photoreceptor;
an image forming unit that forms an electrostatic latent image on a surface of the organic photoreceptor;
a unit to receive a toner formed by the process of preparing latex particles for a core which contain wax by polymerizing a toner composition comprising at least one polymerizable monomer and a macromonomer having a hydrophilic group, a hydrophobic group, and at least one reactive functional group, mixing the latex particles for a core with a self-dispersable pigment dispersion and adding an inorganic salt thereto to prepare a primarily agglomerated toner, and coating latex particles for a shell on the primarily agglomerated toner;
a toner supplying unit that supplies the toner onto the surface of the organic photoreceptor in order to form a toner image by developing the electrostatic latent image on the surface of the organic photoreceptor; and
a toner transferring unit that transfers the toner image to a transfer medium from the surface of the organic photoreceptor.
